(19) United States
(12) Patent Application Publication
(10) Pub. No.: US 2014/0091152 A1
(43) Pub. Date: Apr. 3, 2014

(54) TEMPERATURE SENSOR USING ALUMINUM CAPILLARY

(71) Applicants: Vilnei Carlos Boschetti, Caxias do Sul (BR); Leonardo Harter Da Paz, Caxias do Sul (BR); André Martins, Caxias do Sul (BR)

(72) Inventors: Vilnei Carlos Boschetti, Caxias do Sul (BR); Leonardo Harter Da Paz, Caxias do Sul (BR); André Martins, Caxias do Sul (BR)

(73) Assignee: Invensys Appliance Controls South America, Sao Paulo (BR)

(21) Appl. No.: 13/630,321

(22) Filed: Sep. 28, 2012

(51) Int. Cl. G05D 23/02; B23K 1/00; B23K 1/002; G01K 5/08

(52) U.S. Cl. 236/1 C; 374/201; 374/203; 228/101; 219/616

(57) ABSTRACT

A temperature sensor assembly is provided. The temperature sensor includes an aluminum capillary soldered to an actuation unit. The actuation unit operably fluidly couples to the capillary to define an internal cavity storing a working fluid. The working fluid configured to manipulate the actuation unit when the working fluid changes temperature. Solder sealingly couples the capillary to the actuation unit.

### FIELD OF THE INVENTION

This invention generally relates to temperature sensors for refrigerators such as thermostats and dampers for refrigerators.

### BACKGROUND OF THE INVENTION

Temperature sensors of refrigeration thermostats and damper controls are currently manufactured using a copper capillary. Copper is a high-priced commodity with a price that is constantly increasing in the market. Further, the copper capillary receives a tin bath in order to avoid oxidation and contamination of food inside refrigerators. Further, this avoids galvanic corrosion when in contact with aluminum, such as of the evaporator, due to the difference in electrical potential between these two materials, when in the presence of moisture.

The present invention relates to improvements over the current state of the art as it relates to temperature sensors for refrigerators

### BRIEF SUMMARY OF THE INVENTION

Embodiments of the present invention relate to a new and improved temperature sensor assembly for use in temperature controlled environments and particularly in appliances such as refrigerators and freezers. The new and improved temperature sensor assembly reduces cost by using an aluminum capillary that is lower cost. Additionally, the new and improved temperature sensor assembly avoids oxidation contamination. Methods of forming the temperature sensor assembly as well as thermostats incorporating the temperature sensor assembly are provided.

In one embodiment, the temperature sensor assembly includes an aluminum capillary soldered to an actuation unit to fluidly couple the capillary to the actuation unit and to form an internal cavity storing a working fluid. The working fluid manipulates the actuation unit when the working fluid changes temperature.

In one embodiment the actuation unit is a bellows and the solder sealingly couples an open end of the capillary to an open end of the bellows such that the working fluid can actuate the bellows.

In one embodiment, the temperature sensor assembly includes a sensor body in which the bellows is positioned. The solder seals an open end of the capillary to an internal surface of the sensor body and also seals an open end of the bellows to the internal surface of the sensor body to sealingly couple the bellows to the capillary.

In one embodiment, the bellows is made from a phosphorous bronze; and the sensor body is made from a tin plated steel or aluminum.

In one embodiment, the solder is a Zn/Al solder. More preferably, the Zn/Al solder has about 85 to 99% of Zn, and about 1 to 15% of Al. Even more preferably, the Zn/Al solder includes about 98+/−0.5% of Zn and about 2.0+/−0.5% of Al.

In one embodiment, the solder is a Sn/Zn solder. More preferably, the Sn/Zn solder has about 85 to 99% of Sn, and about 1 to 15% of Zn. Even more preferably, the Sn/Zn solder has about 98+/−0.5% of Sn and about 2.0+/−0.5% of Zn.

In one embodiment, the solder is a Sn/Cu/Ag solder. More preferably, the Sn/Cu/Ag solder has about 99%±0.1% of Sn, about 0.8±0.1% of Cu and 0.2±0.1% of Ag.

In one embodiment, a thermostat comprising a switch assembly and a temperature sensor assembly is provided. The temperature sensor assembly includes an aluminum capillary and an actuation unit operably fluidly coupled to the capillary. The aluminum capillary and actuation unit define an internal cavity storing a working fluid. The working fluid manipulates the actuation unit when the working fluid changes temperature. Solder sealingly couples the capillary to the actuation unit. The actuation unit operably controls the switching unit in response to changes in temperature of the aluminum capillary and corresponding changes in pressure of the working fluid.

In another embodiment, a method of forming a temperature sensor assembly is provided. The method includes soldering an aluminum capillary to an actuation unit to operably fluidly couple the capillary to the actuation unit such that the capillary and actuation unit define an internal cavity for storing a working fluid. The working fluid is configured to manipulate the actuation unit when the working fluid changes temperature.

In a more particular method, the step of soldering is performed by either brazing or induction heating.

In one embodiment, the actuation unit is a bellows formed from a phosphorous bronze and the solder is a Zn/Al solder having about 85 to 99% of Zn, and about 1 to 15% of Al; a Sn/Zn solder having about 85 to 99% of Sn, and about 1 to 15% of Zn; or a Sn/Cu/Ag solder having about 99%±0.1% of Sn, about 0.8±0.1% of Cu and 0.2±0.1% of Ag.

In a further embodiment, the bellows is made from a phosphorous bronze. The step of soldering includes soldering an open end of the capillary to a sensor body defining an internal cavity in which the bellows is positioned. The sensor body is made a tin plated steel or aluminum. The step of soldering also includes soldering an open end of the bellows to the sensor body and soldering the capillary to the sensor body to sealingly couple the capillary to the bellows and form the internal cavity in which the working fluid is stored.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a perspective illustration of a thermostat according to an embodiment of the present invention;

FIG. 2 is a side illustration of a temperature sensor sub-assembly of the thermostat of FIG. 1; and

FIG. 3 is a cross-sectional illustration of the temperature sensor sub-assembly of FIG. 3.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

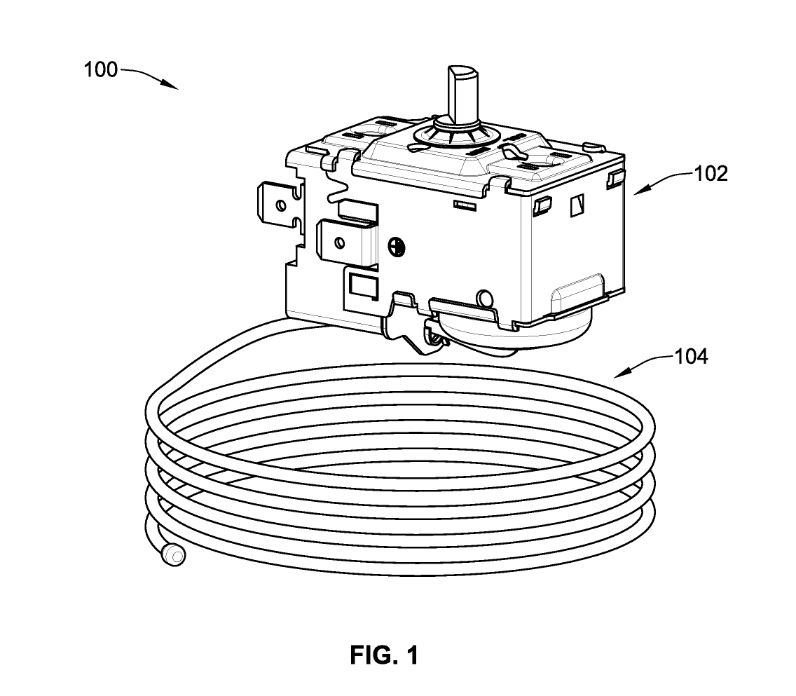

FIG. 1 illustrates a thermostat 100 for use in a refrigerator according to an embodiment of the present invention. While it is intended for the thermostat 100 to be used in a refrigerator, the thermostat 100 can be used in other similar environments and is not limited solely to a refrigerator unless expressly limited.

The thermostat 100 generally includes a switch assembly 102 and a temperature sensor assembly 104. The switch assembly 102 includes the control structure of the thermostat 100 which can be used to turn on or off a compressor of the refrigerator.

The temperature sensor assembly 104 is exposed, at least in part, to the sensed environment where the temperature is being controlled. Changes in the sensed environment are sensed by the temperature sensor assembly 104 and relayed back to the switch assembly 102.

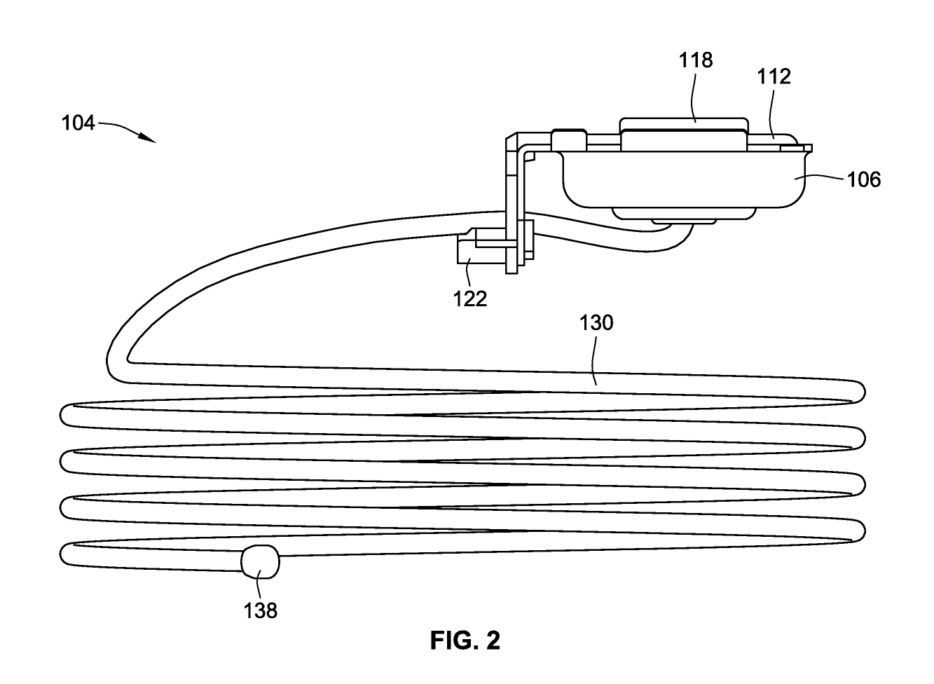

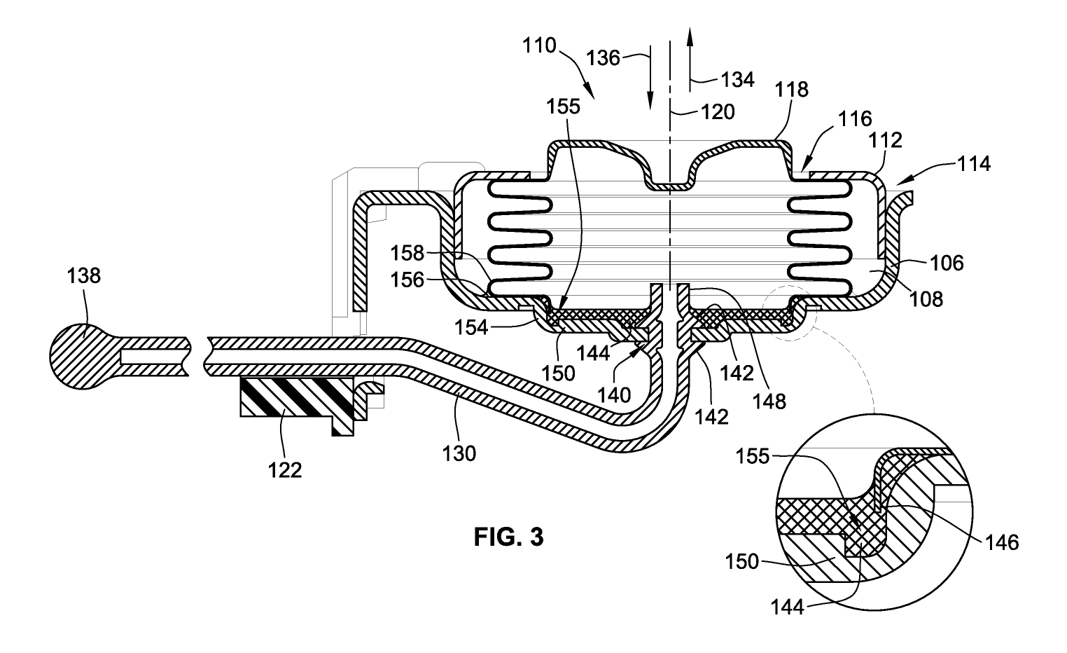

With reference to FIGS. 2 and 3, and with primary reference to the cross-sectional illustration of FIG. 3, the temperature sensor assembly 104 includes a sensor body 106 that defines an internal cavity 108. The sensor body 106 is preferably formed from tin plated steel or aluminum.

A bellows 110 is positioned within the sensor body 106. The bellows 110 is formed from a phosphorous bronze. A bellows keeper 112 is fitted into an open end 114 of the sensor body 106. The bellows 110 includes an actuation portion 118, in the illustrated embodiment, that extends through an aperture 116 formed through bellows keeper 112. The actuation portion 118 of the bellows 110 operably cooperates with and actuates switching structure within the switch assembly 102. The bellows keeper 112 limits the axial expansion of the bellows 110 along axis 120 and may be formed from steel.

An optional dust protector 122 is attached to the sensor body 106 and is preferably formed from a plastic material. The dust protector 122 prevents dust from passing into the temperature controlled environment.

A capillary 130 fluidly communicates with an interior of the bellows 110. The bellows and capillary 130 generally define an internal cavity that is filled with a gas or other fluid that expands and contracts depending on changes in temperature. The capillary will be positioned within the temperature controlled environment so that changes in temperature of the environment cause changes in the pressure of the fluid within the capillary 130. As the fluid rises in temperature the fluid expands raising the pressure within the bellows 110 causing the bellows 110 to expand, and particularly, causing the actuation portion 118 to move along axis 120 in a first direction, illustrated by arrow 134. When the temperature of the fluid drops, the pressure within the bellows 110 drops causing the bellows 110 to contract such that the actuation portion 118 of the bellows move along axis 120 in an opposite second direction, illustrated by arrow 136. This movement of the actuation portion 118 actuates the switching structure within the switch assembly 102 to either turn on or off a unit for controlling the temperature of the temperature controlled environment.

In the illustrated embodiment, the capillary 130 is hollow tubing formed from aluminum. One end of the tubing is closed with a first portion of solder 138. The opposite end of the tubing extends through an aperture 140 in the sensor body 106 and is in fluid communication with the interior of the bellows 110. The end of the tubing may include retaining flanges 142 that secure the tubing in the aperture 140.

A second portion of solder 144 seals the open end 146 of the bellows 110 to the open second end 148 of the capillary 130. In the instant embodiment, the second portion of solder 144 also seals the open end 146 of the bellows 110 to a stepped bottom wall 150 of the sensor body 106. The second portion of solder 144 also seals the open end 148 of the capillary 130 to the stepped bottom wall 150. Preferably, the outer diameter of the open end 146 of the bellows 110 is smaller than the inner diameter of an axially extending portion of a stepped region 154 of the stepped bottom 150 such that a radial gap is formed therebetween. This allows the second portion of solder 144 to fully surround the open end of the bellows 146 and to extend into the gap formed between the stepped region 154 and the open end 146 of the bellows. The stepped bottom 150 may include an annular recess 155 in which the second portion of solder 144 sits to further improve engagement and sealing between the solder 144 and the sensor body 106.

In a preferred embodiment, a third portion of solder 156 is provided between one of the folds 158 of the bellows 110 and the stepped bottom 150 of the sensor body 106. This improves the seal between the bellows and assists in preventing the forces acting on the bellows 110 due to the expansion and contraction of the bellows 110 due to changes in temperature of the fluid from applying stresses to the open end 146 of the bellows 110.

By providing an aluminum capillary 130, the cost of the capillary 130 is significantly reduced. Further, the capillary 130 will not oxidize such that secondary processing of the capillary 130 is not necessary, e.g. tin plating, further reducing cost.

In one embodiment, in order to allow the soldering process between aluminum capillary 100 and sensor body 106, a Zn/Al solder is used. The solder composition may be from 85 to 99% of Zn and from 1% to 15% of Al. The preferred composition is 98.0+/−0.5% of Zn and 2.0+/−0.5% of Al. To solder the bellows 100 and sensor body 106 a Zn/Al solder may be used. The solder composition may be from 85 to 99% of Zn, and 1 to 15% of Al. The preferred composition is 98.0+/−0.5% of Zn and 2.0+/−0.5% of Al. To close the tip of the capillary 130, a Zn/Al solder may be used. The solder composition may be from 85 to 99% of Zn, and 1 to 15% of Al. The preferred composition is 98.0+/−0.5% of Zn and 2.0+/−0.5% of Al.

In another embodiment, a Sn/Zn solder is used. To solder the aluminum capillary 130 to the sensor body 106 the Sn/Zn solder may have from 85 to 99% of Sn and from 1% to 15% of Zn. The preferred composition is 98.0+/−0.5% of Sn and 2.0+/−0.5% of Zn. To solder the bellows 110 to the sensor body 106 the Sn/Zn solder may have the following composition: 85 to 99% of Zn, and from 1 to 15% of Zn. The preferred composition is 98.0+/−0.5% of Sn and 2.0+/−0.5% of Zn. To close the tip of the capillary 130, the Sn/Zn solder may have the following composition: from 85 to 99% of Sn, and 1 to 15% of Zn. The preferred composition is 98.0+/−0.5% of Sn and 2.0+/−0.5% of Zn.

In another embodiment, a Sn/Cu/Ag solder is used. To solder the aluminum capillary 130 to the sensor body 106 the Sn/Cu/Ag solder may have the following composition 99.0+/−0.1% of Sn, 0.8±0.1% of Cu and 0.2±0.1% of Ag. To solder the bellows 110 to the sensor body 106 the Sn/Cu/Ag solder may have the following composition: 99.0±0.1% of Sn, 0.8±0.1% of Cu and 0.2±0.1% of Ag. To close the tip of the capillary 130, the Sn/Cu/Ag solder may have the following composition: 99.0%±0.1% of Sn, 0.8±0.1% of Cu and 0.2±0.1% of Ag.

For all three soldering options above mentioned it is possible to use brazing or induction systems.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A temperature sensor assembly comprising:
an aluminum capillary;
an actuation unit operably fluidly coupled to the capillary, the aluminum capillary and actuation unit defining an internal cavity storing a working fluid, the working fluid configured to manipulate the actuation unit when the working fluid changes temperature; and
solder sealingly coupling the capillary to the actuation unit.

2. The temperature sensor assembly of claim 1, wherein the actuation unit is a bellows; and
the solder sealingly couples the capillary to the bellows such that the working fluid can actuate the bellows.

3. The temperature sensor assembly of claim 2, further comprising a sensor body, the solder seals an open end of the capillary to an internal surface of the sensor body and also seals an open end of the bellows to the internal surface of the sensor body to sealingly couple the bellows to the capillary.

4. The temperature sensor assembly of claim 3, wherein the bellows is made from a phosphorous bronze; and
wherein the sensor body is made from a material selected from the group consisting of: a tin plated steel and aluminum.

5. The temperature sensor of assembly claim 2, wherein the solder is a Zn/Al solder.

6. The temperature sensor of assembly claim 5, wherein the Zn/Al solder has about 85 to 99% of Zn, and about 1 to 15% of Al.

7. The temperature sensor assembly of claim 6, wherein the Zn/Al solder includes about 98+/−0.5% of Zn and about 2.0+/−0.5% of Al.

8. The temperature sensor assembly of claim 6 further comprising a sensor body defining an internal cavity in which the bellows is positioned, the sensor body being made from a material selected from the group consisting of: a tin plated steel and aluminum;
wherein the bellows is made from a phosphorous bronze; and
the solder sealing the capillary to the sensor body and sealing the sensor body to an open end of the bellows to sealingly couple the capillary to the bellows.

9. The temperature sensor assembly of claim 2, wherein the solder is a Sn/Zn solder.

10. The temperature sensor assembly of claim 9, wherein the Sn/Zn solder has about 85 to 99% of Sn, and about 1 to 15% of Zn.

11. The temperature sensor assembly of claim 10, wherein the Sn/Zn solder has about 98+/−0.5% of Sn and about 2.0+/−0.5% of Zn.

12. The temperature sensor assembly of claim 11 further comprising a sensor body defining an internal cavity in which the bellows is positioned, the sensor body being made from a material selected from the group consisting of: a tin plated steel and aluminum;
wherein the bellows is made from a phosphorous bronze; and
the solder sealing the capillary to the sensor body and sealing the sensor body to an open end of the bellows to sealingly couple the capillary to the bellows.

13. The temperature sensor assembly of claim 2, wherein the solder is a Sn/Cu/Ag solder.

14. The temperature sensor assembly of claim 13, wherein the Sn/Cu/Ag solder has about 99%±0.1% of Sn, about 0.8±0.1% of Cu and 0.2±0.1% of Ag.

15. The temperature sensor assembly of claim 14 further comprising a sensor body defining an internal cavity in which the bellows is positioned, the sensor body being made from a material selected from the group consisting of: a tin plated steel and aluminum;
wherein the bellows is made from a phosphorous bronze; and
the solder sealing the capillary to the sensor body and sealing the sensor body to an open end of the bellows to sealingly couple the capillary to the bellows.

16. A thermostat comprising:
a switch assembly;
a temperature sensor assembly comprising:
an aluminum capillary;
an actuation unit operably fluidly coupled to the capillary, the aluminum capillary and actuation unit defining an internal cavity storing a working fluid, the working fluid configured to manipulate the actuation unit when the working fluid changes temperature; and
solder sealingly coupling the capillary to the actuation unit;
wherein the actuation unit operably controls the switching unit in response to changes in temperature of the aluminum capillary.

17. A method of forming a temperature sensor comprising:
soldering an aluminum capillary to an actuation unit to operably fluidly coupled the capillary to the actuation unit such that the capillary and actuation unit define an internal cavity storing a working fluid, the working fluid configured to manipulate the actuation unit when the working fluid changes temperature.

18. The method of claim 17, wherein the step of soldering is performed by either brazing or induction heating.

19. The method of claim 17, wherein the actuation unit is a bellows formed from a phosphorous bronze and the solder is selected from the group consisting of:
a Zn/Al solder having about 85 to 99% of Zn, and about 1 to 15% of Al;
a Sn/Zn solder having about 85 to 99% of Sn, and about 1 to 15% of Zn; and
a Sn/Cu/Ag solder having about 99%±0.1% of Sn, about 0.8±0.1% of Cu and 0.2±0.1% of Ag.

20. The method of claim 19, wherein:
the bellows is made from a phosphorous bronze;
the step of soldering includes soldering an open end of the capillary to a sensor body defining an internal cavity in which the bellows is positioned, the sensor body being made from a material selected from the group consisting of: a tin plated steel and aluminum; and
the step of soldering also includes soldering an open end of the bellows to the sensor body to sealingly couple the capillary to the bellows and form the internal cavity in which the working fluid is stored.
